(19) United States
(12) Patent Application Publication
(10) Pub. No.: US 2018/0095950 A1
(43) Pub. Date: Apr. 5, 2018

(54) SYSTEMS AND METHODS FOR COMPLETE TRANSLATION OF A WEB ELEMENT

(71) Applicant: LINGUA NEXT Technologies PVT. LTD., Pune (IN)

(72) Inventor: Rajeevlochan PHADKE, Pune (IN)

(73) Assignee: LINGUA NEXT Technologies PVT. LTD., Pune (IN)

(21) Appl. No.: 15/286,468

(22) Filed: Oct. 5, 2016

(51) Int. Cl. G06F 17/28; G06F 17/27; G06F 17/22

(52) U.S. Cl. CPC G06F 17/289; G06F 17/2247; G06F 17/2705

(57) ABSTRACT

Embodiments of the present invention relate to systems and methods for complete translation of a web element. In one embodiment, the present invention encompasses a system comprising: a transceiver unit [402] for receiving a request for complete translation of a web element; a runtime engine [404] for parsing the one web element to identify a dynamic content, wherein the dynamic content may be in form of a code and a translatable text, further contains a fixed and a varying text. Further, the system comprising: a parser [406] for extracting the translatable text from the code; a translation engine [408] for translating all the translatable text from a source language to a target language; a web element re-composer [410] for recomposing the web element in the target language by replacing all the translatable text in the source language.

### FIELD OF THE INVENTION

In general, the present invention relates to methods and systems of translation. More particularly, the invention relates to methods and systems that perform complete translation of a web element from a source language to a target language.

### BACKGROUND

The following description of related art is intended to provide background information pertaining to the field of the present disclosure. This section may include certain aspects of the art that may be related to various aspects of the present disclosure. However, it should be appreciated that this section be used only to enhance the understanding of the reader with respect to the present disclosure, and not as admissions of prior art.

Internet is a widespread platform for users to gain and share information by accessing web elements such as websites, web pages, web applications, etc. Typically, a website/web page comprises of text content, multimedia content for instance images with/without text, videos, etc.; downloadable documents, such as pdf, xls, doc, csv documents, etc.

Web elements may be represented in the form of a standard Document Object Model (DOM), wherein there is HTML/XHTML content in a web element which is represented in a tree structure where each node is an object representing a part of the document. A majority of the text content of a web element, say 85%, is part of a standard HTML DOM tree. The remaining content on/within the web elements is dynamic content embedded in the source code.

Generally, text/data in any of the afore-mentioned content on web elements is provided in a natural language such as English, Spanish, French, etc. However, in order to be able to make most effective use of the information present on these web elements, it is imperative to translate these elements into natural languages, other than the source language that the user is familiar with. To achieve this, a number of translation solutions have been developed and used, wherein translation is performed using conventional approaches such as in-place static translation, page duplication, mirroring, etc. However, the existing translation solutions have a number of limitations and drawbacks.

Existing translation solutions are capable of locating, extracting and translating text present in standard HTML elements and to a very limited extent capable of locating, extracting and translating dynamic contents with “fixed” text/data. However, for such solutions, it is practically impossible to locate, extract and translate dynamic contents with “varying” text/data. The proportion of dynamic content on web elements, and particularly web applications, is increasing manifold with time, and thus not being able to translate such content is a major drawback of the existing translation solutions. These solutions are also unable to translate dynamic contents containing variable sub-text.

The text/data contained in the dynamic content cannot be translated by the existing translation solutions, since the text/data is embedded inside the code. This text/data contains translatable text, wherein identification of the “translatable text” from dynamic content is extremely complex and difficult and practically impossible with existing translation solutions.

For instance, there may be an overlap between translatable text and variable names, function names, parameters, commands, etc. The existing solutions are unable to translate such content because they are unable to completely distinguish and extract “translatable text” from the dynamic content of the web element, which leads to an incomplete translation of the web element.

For instance, the word “print” may be a part of the text desired to be translated and can also appear as part of the source code as in the following code snippet:

<Script type=“text/javascript”>
if (window.print) {
document.write(‘<form><input type=“button” name=“print” value=“Print”
onClick=“window.print( )”></form>’);
}
</Script>

Existing solutions are unable to distinguish between translatable text and code and thus are not capable of completely translating web elements. Therefore, it can be concluded that existing solutions are not a “complete” translation solution.

Moreover, the existing translation solutions do not provision altering the format of the translated webpages. In some cases it may be essential to carry out custom processing to change the text orientation, change the data format e.g. change the date from “mm/dd/yyyy” to “dd/mm/yyyy”, alter the size of the web elements such as panes, buttons, etc. in order to present the translated web elements in a format that is easy to read and understand for the user. For example, for Arabic language, it is essential that the website text is aligned ‘Right to left’. However, no such functionality (with respect to layout or data format change) is provided by the existing translation solutions.

Also, none of the existing translation solutions are capable of adequately distinguishing, identifying and translating a string containing variable texts such as end user messages E.g. error messages. This is mainly because, none of the existing translation solutions are capable of identifying and translating the variable texts and fixed texts in a string E.g. “Notification sent to group SYS202” where “Notification sent to group” is fixed text and “SYS202” is variable text. In a few existing solutions, the strings having fixed texts and variable texts are translated repetitively, even when the fixed texts are just mere repetition; however, doing such may result in reducing the efficiency of the system and increase the cost of translation.

In view of the above and other known drawbacks, there is a need for developing a system and method that can efficiently translate web elements from one language to another while also alleviating or at least substantially reducing the above-mentioned problems. Further, it is required to provide a solution of “full translation of a web element” which is not delivered by the existing solutions. This includes locating, extracting and translating “translatable texts” embedded within the dynamic content; wherein locating the “translatable text” is extremely complex and difficult.

### SUMMARY

This section is provided to introduce certain objects and aspects of the disclosed methods and systems in a simplified form that are further described below in the detailed description. However, this summary is not intended to identify the key features or the scope of the claimed subject matter.

One object of the present invention is to provide methods and systems for complete translation of a web element from a source language to a target language, that substantially overcomes the drawbacks of the prior art systems.

Another object of the present invention is to provide a completely externalized configurable solution for facilitating complete translation of a web element, such that the original source code of the said web element remains unaltered during and after translation.

Another object of the invention is to provide methods and systems for complete translation of a web element that periodically monitors the web element for and translates any new untranslated content found therein.

Yet another object of the invention is to provide methods and systems for complete translation of a web element that is capable of effectively extracting all translatable text from the source code of the web element.

Another object of the invention is to provide methods and systems for complete translation of a web element that facilitates replacement of the translatable text with the translated text to provide translated web element.

In view of these and other objects, one aspect of the present disclosure relates to a method for complete translation of a web element, from a source language to a target language.

The method comprises receiving a request for complete translation of a web element, in response to which, parsing said at least one web element to identify one of a standard document object model tree, at least one dynamic content and combination thereof, wherein the parsing is one of a standard parsing of the at least one web element, a preconfigured parsing and combination thereof, and the at least one dynamic content contains at least one code and at least one translatable text; Further, step comprises, extracting at least one translatable text from the at least one code identified in the at least one dynamic content; translating the at least one translatable text in the source language to at least one translated text in the target language; and subsequently, re-composing the at least one web element in the target language by replacing the at least one translatable text in the source language to at least one translated text in the target language.

Another aspect of the present disclosure relates to a system for complete translation of a web element, from a source language to a target language. The system comprises: a transceiver unit [402] for receiving a request for complete translation of at least one web element; a runtime engine [404] configured with the transceiver unit [402] for parsing the at least one web element to identify at least one dynamic content, wherein the parsing is one of a standard parsing of the at least one web element, a preconfigured parsing and combination thereof, and the at least one dynamic content contains at least a code and at least one translatable text. Further, the system comprises: a parser [406] configured for extracting at least one translatable text from the at least one code identified in the at least one dynamic content; a translation engine [408] associated with said parser [406] for translating the at least one translatable text in the source language to at least one translated text in the target language; and a re-composer [410] associated with said parser, configured for the at least one web element in the target language by replacing the at least one translatable text in the source language to at least one translated text in the target language.

### BRIEF DESCRIPTION OF DRAWINGS

The accompanying drawings, which are incorporated herein, and constitute a part of this disclosure, illustrate exemplary embodiments of the disclosed methods and systems in which like reference numerals refer to the same parts throughout the different drawings. Some drawings may indicate the components using block diagrams and may not represent the internal circuitry of each component. It will be appreciated by those skilled in the art that disclosure of such drawings include disclosure of electrical components or circuitry commonly used to implement such components.

FIG. 1 illustrates a block diagram indicating a web element and the technologies and content thereof, in accordance with example embodiments of the present disclosure.

FIG. 2 illustrates the location of translatable text on a web element, in accordance with example embodiments of the present disclosure.

FIG. 3 illustrates a general overview of the system for facilitating complete translation of a web element, in accordance with example embodiments of the present disclosure.

FIG. 4 illustrates the system for complete translation of a web element from a source language to a target language, in accordance with example embodiments of the present disclosure.

FIG. 5 illustrates a central data repository in accordance with example embodiments of the present disclosure.

FIG. 6 illustrates a method for facilitating complete translation of a web element, in accordance with example embodiments of the present disclosure.

### DETAILED DESCRIPTION OF DRAWINGS

In the following description, for the purposes of explanation, various specific details are set forth in order to provide a thorough understanding of the disclosed embodiments. It will be apparent, however, that the disclosed embodiments may be practiced without these specific details. Several features described hereafter can each be used independently of one another or with any combination of other features. However, any individual feature may not address any of the problems discussed above or might address only some of the problems discussed above in the background section. Some of the problems discussed above might not be fully addressed by any of the features described herein. Although headings are provided, information related to a particular heading, but not found in the section having that heading, may also be found elsewhere in the specification. Further, information provided under a particular heading may not necessarily be a part of only the section having that heading.

As discussed herein, a “web element” refers to any document located/stored on the World Wide Web, such as HTML documents, web pages, web sites, web applications and any other equivalent document located on the web, as may be obvious to a person skilled in the art.

As discussed herein, a “web server” refers to any computer system and/or the software that serves, delivers and/or stores web elements. In a preferred embodiment, the web server processes requests received via Hypertext Transfer Protocol.

As discussed herein, “user device” refers to any computing device, including, but not limited to, a mobile phone, smart phone, pager, laptop, a general purpose computer, desktop, personal digital assistant, tablet computer, mainframe computer, or any other computing device as may be obvious to a person skilled in the art.

As used herein, “translatable text” refers to any text on a web element that is capable of, or is required/desired to be translated.

The term “dynamic content” refers to text/data that is not a part of the standard DOM and that which is inserted on the fly into the DOM due to the execution of HTML Internal <script> tags, JavaScript, Dynamic HTML; also comprises of text/data in standard/non-standard JSON (for example non-standard JSON that does not comply with ECMA-404 standard)/DWR/XHR, HTML form data e.g. post data and data in non-standard and proprietary data formats; also comprises of images, documents, URLs and a combination thereof.

Further on, based on the nature of text/data, dynamic content can be:
I. Fixed: Text/data inside the dynamic content is “fixed” in nature and does not change. E.g. Text value assigned to a variable inside a JavaScript file.
II. Varying: Text/data inside the dynamic content is “varying” in nature and keeps changing. E.g. Text inside an HTML Internal <script> tag contained in a variable sub-text.

As discussed herein, “source language” and “target language” are natural languages, i.e. language that is used and/or understood by human users. Natural language may include, but is not limited to, English, Hindi, Chinese, Spanish, Arabic, Russian, Japanese, French, etc.

As discussed herein, “code” and “source code” of a web element refers to a collection of computer instructions written using any computer language, such that these instructions when executed are capable of providing said web element.

As used herein, the “configuration phase” refers to the phase of identifying, extracting and pre-configuring from one or more web elements. The preconfiguring includes, but not limited to, defining pre and post processing conditions for one or more translatable text, layout, text/data format changes etc. of the web element.

As used herein, the “run time phase” refers to a phase of translating and re-composing one or more web elements as per the pre-configuration, wherein the pre-configuration may be called in a custom defined manner or as-and-when there is an incomplete translation of the web element after running a standard translation mechanism.

As used herein, a “processor unit”, a “processing engine” and a “processor” includes one or more processors, wherein processor refers to any logic circuitry for processing instructions. A processor may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), etc. The processor may perform signal coding, data processing, power control, input/output processing, and/or any other functionality that enables the working of the system according to the present disclosure.

### General Overview

In general, the present invention relates to methods and systems for facilitating complete translation of a web element from a source language to a target language.

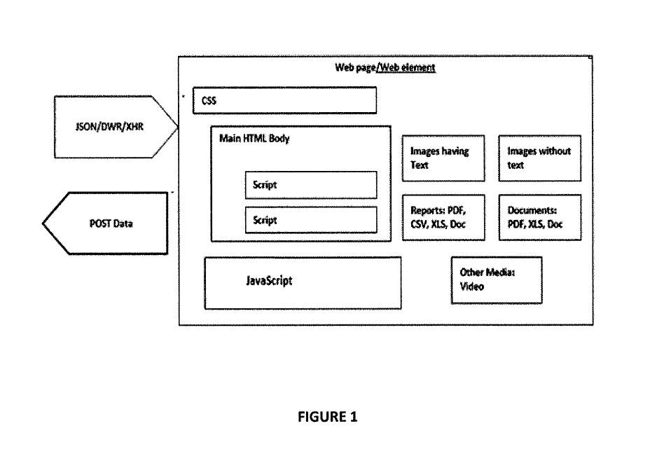

FIG. 1 illustrates a block diagram indicating a web element and the technologies and content thereof, in accordance with example embodiments of the present disclosure. As shown in FIG. 1, a web element comprises of text content; multimedia content for instance images with/without text, videos, etc.; documents and reports, in formats such as pdf, xls, doc, etc. Further, FIG. 1 shows the popular web technologies used in building a web element, including, but not limited to, Hypertext Markup Language (HTML). Also used herein, the Cascading Style Sheets (CSS) that facilitate creating the design of the web element, CGI that enables connection to the database, JavaScript and Internal <Script> tags that add functionality to the web element, JSON/DWR/XHR that facilitates reading data from the web server and displaying it on the web element. Furthermore, HTTP methods GET and POST facilitate communication between a client and a server, wherein GET requests data from a web server and POST submits data to be processed to a web server.

The content of a web element may comprise one or more translatable texts. The translatable text may exist as a part of a standard DOM or may exist as a part of the dynamic content.

For the ease of reference in this disclosure, complex to locate translatable texts have been categorized as:
1. Category I—Translatable texts in HTML Internal <Script> tags. The translatable text may appears in one of or combination thereof:
   a. XHTML/XML buffer and buffer inside HTML Internal <Script> tag;
   b. Standard/non-standard JSON and standard/non-standard JSON inside HTML Internal <Script> tag;
   c. JavaScript function and JavaScript function inside HTML Internal <Script> tag; and
   d. Variable subtext wherein the variable is inside the HTML Internal <Script> tag.
2. Category II—Translatable texts in JavaScript. The translatable text may appears in:
   a. Variable subtext, wherein variable is inside a JavaScript file;
   b. XHTML tags, wherein XHTML is inside a JavaScript file;
   c. Standard/non-standard JSON, wherein said standard/non-standard JSON is assigned to a variable inside a JavaScript file;
   d. JavaScript function inside a JavaScript file;
3. Category III—Translatable texts in other HTML tags (other than HTML Internal <Script> tag). Translatable text appears in:
   a. Form data inside HTML tags e.g. post data;
   b. Non-standard data inside HTML tags;
   c. Text/Plain (Proprietary) format inside HTML tags;
   d. JS functions called by HTML tag attributes inside HTML tags;
4. Category IV—Translatable texts in JSON/XHR/DWR. Translatable text appears in:
   a. XHTML buffer (in XHR);
   b. JS in Text/Plain (Proprietary) format;
   c. Text/Plain (Proprietary) format, wherein this text appears in standard/non-standard JSON/XHR/DWR;
   d. Text/Plain (Proprietary) format, wherein this text appears in XHTML;
   e. JSON/XHR/DWR Text/Plain (Proprietary) format separated by delimiters;
   f. POST data and RESPONSE data;
5. Category V—Translatable texts in Form Data: Translatable text appears in:
   a. Various dropdowns/combos in a web form;
   b. POST data;
   c. GET data

The above-mentioned categories are only exemplary and it will be appreciated by those skilled in the art that the translatable text contained in any of these categories, or otherwise, may also be translated by the systems and methods encompassed by this disclosure.

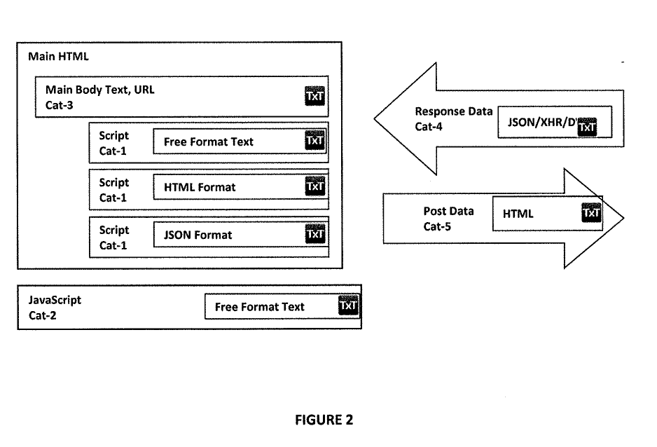

FIG. 2 illustrates the location of translatable text on a web element, in accordance with example embodiments of the present disclosure. As shown in FIG. 2, translatable text may be located in the one or more elements as well as in the locations specified in the categories I-V listed above and more locations. It will be appreciated by those skilled in the art that FIG. 1 and FIG. 2 are only exemplary embodiments, and other content types, web technologies and locations of translatable text are encompassed by this disclosure.

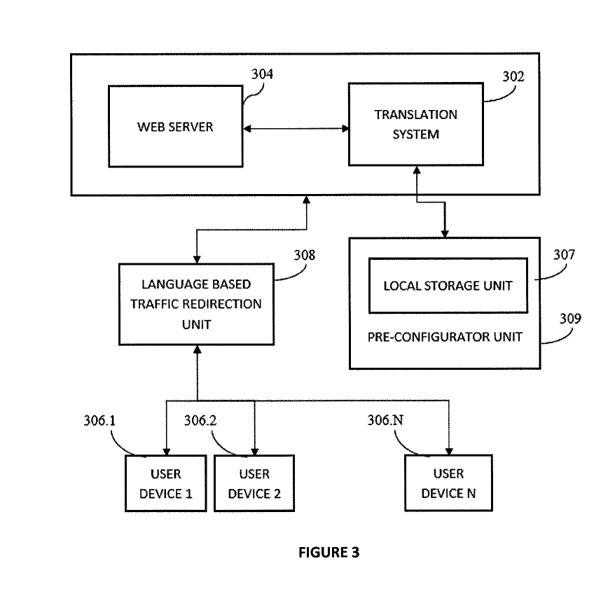

FIG. 3 illustrates a general overview of the system and method for complete translation of a web element, in accordance with example embodiments of the present disclosure. The invention encompasses a translation system [[302]] configured to operate with a web server [304], wherein one or more web elements are placed/stored/located/served on said web server [304]. A user accesses a web element placed on the web server [304], through a user device [306] via a language based traffic redirection unit [308] and/or translation system [302]. The language based traffic redirection unit [308] is a physical/logical sub-network that connects the user devices to the web servers [304]. In a preferred embodiment, the language based traffic redirection unit [308] performs other function of a DMZ (with reference to computing) as may be obvious to a person skilled in the art.

In an example embodiment, a user sends a request to view a web page in English language, through the user device [306].1. The language based traffic redirection unit [308] determines the source language of the web page. If the source language of the requested web page is same as the language requested by the user, i.e. English in this case, the request is redirected directly to the web server [304]. The desired webpage is then retrieved and displayed to the user through/on the user device [306].1.

In another example embodiment, the user requests for a webpage in Japanese language through the user device [306].2. The language based traffic redirection unit [308] determines the source language of the web page. If the source language of the web page is different from that of the requested language, for instance, in this case considering that the source language of the requested web page is English and requested language is Japanese, this request is redirected to the translation system [302]. The translation system [302] then retrieves the requested web page in the source language from the web server [304] and parses the web page, as per the design time configuration, extracts the text and/or processes the text, layout, format, replaces the source language text with the translated text, recomposes the web page and thus which is then provided to the user through the user device [306].2.

In an alternate embodiment, the user devices [306] interact with the translation system [302] directly, i.e. without the intervention of the language based traffic redirection unit [308]. The request for a web page from the user device [306] is received at the translation system [302], which determines the source language of the web page and translates the requested webpage, if required, before providing it to the user through the user device [306].

The invention encompasses a translation system [302] that communicates with one or more web servers [304] simultaneously. Further, the invention encompasses multiple user devices [306] that can request for one or more web pages in different languages simultaneously. The invention encompasses translation of contents shown in FIGS. 1 and 2 using a translation system as shown in FIG. 3. It will be appreciated by those skilled in the art that FIG. 3 shows only an exemplary environment in which the translation system [302] is located/situated/used, and other variations/embodiments of this environment may be possible and fall within the scope of this disclosure.

Thus, the translation system [302] is capable of locating translatable text in the code, including text present within Categories I-V, extracting said translatable text as per the design time configuration. At runtime, the system is capable of translating the extracted text, recomposing the web element and providing the same to the user.

The invention encompasses translation of translatable text comprising one or more text patterns, wherein a text may be a simple string, a string containing numeric variables, string containing alphanumeric variables, string containing alphabetical variables, string containing specially formatted variable(s) e.g. date/time.

In an embodiment, translatable text is such that it requires format transformation/value mapping, for instance, a numeric with decimal points that may require change of decimal character, text comprising a date that requires format transformation, text comprising a date/time value that requires value change as per time zone selection and also requiring format transformation, etc.

### System Overview

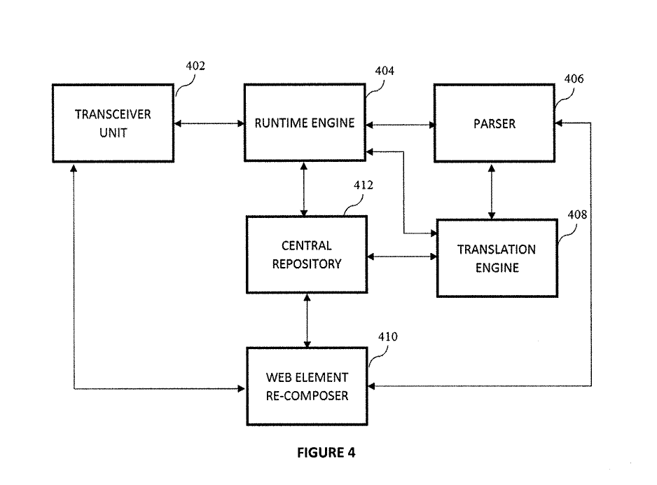

FIG. 4 illustrates the system for complete translation of a web element from a source language to a target language, in accordance with example embodiments of the present disclosure.

As shown in FIG. 4, the translation system [[302]] comprises of a transceiver unit [402] connected to a runtime engine [404] which is further connected to a parser [406], a central database [412] and a translation engine [408]. The translation system [[302]] also comprises a web element re-composer [410] connected to the transceiver unit [402], central database [412] and the translation engine [408]. Though connections between various units of the translation system [[302]] are shown via solid lines in FIG. 3, it will be appreciated that other connections between units may also be possible and are encompassed by this disclosure.

The transceiver unit [402] is configured to accept one or more requests for complete translation of a web element from a source language to a target language. The transceiver unit [402] transmits the same to the runtime engine [404]. The invention encompasses a transceiver unit [402] that is capable of accepting requests for translation from a user.

The runtime engine [404] is configured to receive said request from the transceiver unit [402] and monitor said web element to identify all dynamic content in the web element, wherein each of said dynamic content contains at least a code, and a translatable text in the source language. The runtime engine [404] is further configured to store these identified dynamic content containing translatable text, in the central database [412] and also provide this information to the parser [406].

The parser [406] is configured to accept one or more dynamic content containing translatable text, from the runtime engine [404] and parse the contents of each of the dynamic content to extract translatable text from code as per the design time configuration thereof.

The extracted translatable texts are provided by the parser [406] to the translation engine [408], which translates all the translatable text from source language to target language. The translation engine [408] is further configured to store all translated text in the central database [412] and provide the same to the web element re-composer [410].

The translation engine [408] replaces the translatable text by the translated text and the web element re-composer [410] provides the re-composed web element to the transceiver unit [402]. The central database [412] is configured to store all data/information generated, processed and/or stored by one or more units of the translation system [[302]. The central database [412] is discussed below in detail with reference to FIG. 3.

The invention encompasses a pre-configurator unit [309]. The pre-configurator unit is a completely externalized solution to facilitate pre-configuration of dynamic content that is difficult to locate, extract and translate E.g. Dynamic content mentioned in categories I-V in the General Overview section. In an embodiment, the pre-configurator unit comprises a regular expression generator module for quick and easy generation of regular expression code. The regular expression generator aids the system [[302]] in identifying translatable text from the dynamic content. The generation of regular expression code has been discussed in the Method Overview section.

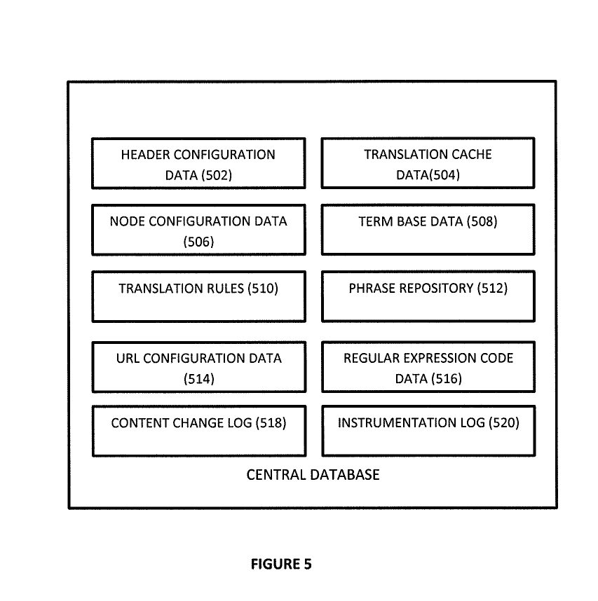

FIG. 5 illustrates a central data repository in accordance with example embodiments of the present disclosure. As shown in FIG. 5, the central database [412] comprises of one or more databases/tables configured to store a header configuration data, a translation cache data, a node configuration data, a term base data, a set of translation rules, a set of phrases, a URL configuration data, a regular expression code data, a content change log and an instrumentation log. The header configuration data comprises page header information for one or more web elements; the translation cache data comprises cache information after the page is translated; the term base data comprises one or more dictionaries; and the translation rules comprise of the rules that can be applied to specific web elements, for instance whether said web element is to be translated or not. The set of phrases comprises at least one or more dictionaries; the URL configuration data comprises the URL information for each web element; and the regular expression code data comprises code and regular expression information required or generated by the system. Content change log keeps a log of the contents added/edited on the web pages. The Instrumentation log keeps a log of the events for the various components of the system. The node configuration data maintains the information regarding translation of specific web element nodes.

### Method Overview

### A. Design-Time Configuration by Pre-Configurator Unit:

The following are the steps performed in configuring the system for translation.

### 1. Analyze:

In this step, the system detects/identifies all the text present in the web element including the dynamic content and analyzes it. In this phase, dynamic content containing translatable text is identified.

### 2. Configuring Identifiers/Keys/Regex:

In this step, the all the translatable texts are configured with identifiers/keys for further processing. In some embodiments, regular expressions are used for demarcating the translatable texts that need to be processed and/or translated.

### 3. Applying Parsers:

In this step, all the translatable texts are extracted by applying appropriate parsers.

### 4. Exporting Text for Translation:

In this step, all the extracted texts are exported for translating into target languages. The translated texts are stored in the local storage unit [307] of a pre-configurator unit [309].

### 5. Analyze Untranslated Text & Configuration for Untranslated Text:

Text that is translatable but which appears untranslated on the target web elements is analyzed in preview mode. In certain embodiments, regular expressions for identifying this translatable text and respective configuration conditions are stored in the local storage unit [307].

### 6. Publish Configuration Data and Translated Texts:

In this step, the translated text along with the respective configuration is published in a database which is used while executing on-the-fly translation in the Run Time phase.

All design time configuration steps listed above are fully automated and require minimal manual intervention; thus providing an easy to adopt methodology and a “complete” solution delivery with reduced time to market.

In a preferred embodiment, a regular expression code for one or more said dynamic content is used to identify and extract translatable text from code. Generating regular expression includes identifying translatable text. After translatable text is identified, parameters for matching the translatable text contained in the web elements with already defined regular expression code are defined and stored in the local storage unit [307].

For instance, when a string containing one or more alphabetical variables are identified, such as “No Direct Trains Found For Pune JN—PUNE to PORBANDAR—PBR on 17-Jun-2016”, regular expression code for the same is configured at designed time to identify fixed and variable text as follows:
Fixed text identified: No Direct Trains Found For; to; on 17-Jun-2016
Variable text identified: Pune JN—PUNE; PORBANDAR—PBR

The variable text may be marked with placeholders such as <A 0> for Pune JN—PUNE and <A 1> for PORBANDAR—PBR.

In an embodiment, step [309] includes considering the context of the translatable text while extracting.

### B. Run Time Workflow:

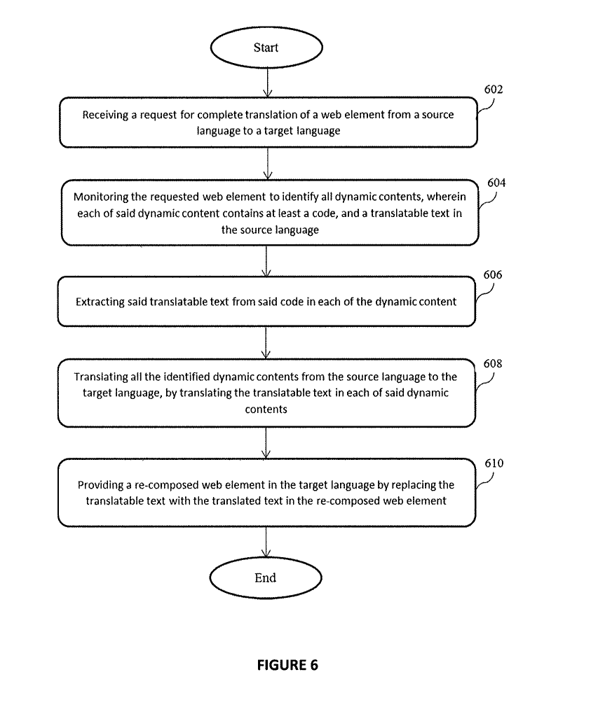

FIG. 6 illustrates a method for facilitating complete translation of a web element, in accordance with example embodiments of the present disclosure. As shown in FIG. 4, method [600] begins at step [602], wherein a request for complete translation of a web element from a source language to a target language, is received at the transceiver unit [402]. The invention encompasses receiving a request from a user device [[306]] when a user enters a URL of a web element and a target language in which said web element is desired to be viewed. The invention also encompasses receiving a request from a user device [[306]] when a user selects to translate an already retrieved web page into a target language on the web browser. The invention also encompasses receiving a request from a user device [[306]] when a user navigates to another URL from the existing web element, wherein a default target language has been selected by the user. In a preferred embodiment, the received request is processed to assign a unique request number thereto.

The invention encompasses qualifying the request/requested web element/URL of the web element, before proceeding to step [604]. This includes identifying whether the requested web element is to be translated.

Subsequently, at step [604], the requested web element is monitored to identify all dynamic content, wherein each of said dynamic content comprises at least a code, and a translatable text in the source language. This monitoring of the web element may also be done automatically and periodically by the translation system [[302]] for each requested web element. In an embodiment, the monitoring is performed until the user/administrator explicitly stops such monitoring for one or more web elements. In another embodiment, monitoring is performed until said web element is no longer available.

Monitoring a web element to identify all dynamic content that may contain at least one code, a translatable text and combination thereof. Further, the monitoring includes identifying all the dynamic content in the web element and considering those dynamic content that are likely to contain a translatable text, wherein the dynamic contents and extracted based on a pre-configuration. Further, monitoring a web element also encompasses periodically scanning the web element to identify any change to the content therein, i.e. if any new content has been added, any content has been deleted or modified since the previous translation.

Next, translatable text in each of the dynamic content is extracted from said code, at step [606], by parsing each of the dynamic content identified in the previous step, and selecting each translatable text therein. In an embodiment, translatable text and code contained in the web elements is then matched with the regex.

At step [608], all the identified dynamic content are translated from the source language to the target language, by translating the translatable text in each of said dynamic content. This step includes receiving the identified dynamic content and the corresponding translatable text contained in each of these along with the unique request number. The translation engine [408] then retrieves the target language associated with said request and begins the process of translation. The invention encompasses translating by searching a database of corresponding target language stored in the central database [412] to determine if a translation of the translatable text already exists in said target language database.

In an embodiment, translation of translatable text is done on a word by word basis while maintaining the context of the translatable text. In another embodiment, translation of translatable text is done by phrase by phrase. In another embodiment, translation methods such as machine translation etc. are used in step [608].

At step [610], a re-composed web element in the target language is provided to the user, wherein re-composed web element is formed by replacing the translatable text with the translated text in the web element. For instance, a JavaScript file is recomposed by replacing translatable text in the original JavaScript file by corresponding translated text therein. In an embodiment, the steps [602] to [610] are performed at run-time phase.

In an embodiment, in addition to translation of various dynamic contents, the translation method is capable of changing HTML element attributes, for instance, page layout transformation, changing the text orientation, altering the size of the panes, buttons, etc. The system and methods encompassed by the disclosure is capable of detecting based on the configuration if any such change in HTML attributes is required to be made based in the change in language. For instance, when a web element is translated from English to Arabic, the system, based on the configuration stored, detects that the orientation of the entire web element is required to be changed to ‘right to left’.

The above-mentioned method [600] is also capable of processing and translating texts in non-standard data formats and/or proprietary data formats.

### Hardware Overview

According to one embodiment, the techniques described herein are implemented on one or more special purpose multi-connection, multi-threaded servers, wherein in a preferred embodiment these servers are cloud servers. The invention encompasses a translation system [302] comprising of at least an Apache hosted web page interceptor, a PDF translation engine, an in-memory database and translation management and maintenance tools. The translation system [302] may be deployed on any Windows/Linux server, wherein these servers may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques. The web servers referred to herein are main application servers on the Internet.

In an example embodiment, the translation system [302] may include a bus or other communication mechanism for communicating information, and a hardware processor coupled with bus for processing information. Hardware processor may be, for example, a general purpose microprocessor. The system also may include a main memory such as a random access memory (RAM) or other dynamic storage device, coupled to bus for storing information and instructions to be executed by processor. Main memory also may be used for storing temporary variables or other intermediate information during execution of instructions to be executed by processor. Such instructions, when stored in non-transitory storage media accessible to processor render computer system into a special-purpose machine that is customized to perform the operations specified in the instructions.

The system further may include a read only memory (ROM) or other static storage device coupled to bus for storing static information and instructions for processor. A storage device such as a magnetic disk, optical disk, or solid-state drive is provided and coupled to bus for storing information and instructions.

According to one embodiment, the techniques herein are performed by system in response to processor executing one or more sequences of one or more instructions contained in main memory. Such instructions may be read into main memory from another storage medium, such as storage device. Execution of the sequences of instructions contained in main memory causes processor to perform the process steps described herein. In alternative embodiments, hard-wired circuitry may be used in place of or in combination with software instructions.

The term “storage unit” and “central repository” as used herein refers to any non-transitory media that store data and/or instructions that cause a machine to operate in a specific fashion.

Storage unit is distinct from but may be used in conjunction with a transmission media, wherein said transmission media participates in transferring information between different modules/units of the system. For example, transmission media may include coaxial cables, copper wire and fiber optics, including the wires that comprise bus. Transmission media can also take the form of acoustic or light waves, such as those generated during radio-wave and infra-red data communications.

The system [302] can send messages and receive data, including program code, through the network(s), network link and communication interface. The system [302] may also be connected to the web servers via one or more network links that typically provide data communication through one or more networks to other data devices. The signals through the various networks and the signals on network link which carry the digital data to and from system are example forms of transmission media.

While a hardware overview of the invention has been provided herein above, the invention claimed and described in this disclosure is not limited to any computer hardware, software, middleware, firmware, etc.

In a preferred embodiment, the translation process is configured at Design time and executed at Runtime. The invention encompasses execution of the translation process in an optimal manner and within such time interval that the page latency is maintained at all times. Further, the methods and systems encompassed by this disclosure result in significant reduction in cost and time since persons with lesser skill can perform the tasks, most of the configuration is automated and human intervention is minimal.

While this invention has been particularly shown and described with references to example embodiments thereof, it will be understood by those skilled in the art that various changes in form and details may be made therein without departing from the scope of the invention. Further, a person having ordinary skill in the art will appreciate that the system and modules/units thereof, discussed herein above are exemplary and are not limiting in any manner. Furthermore, the modules/units and steps described herein above may be replaced, reordered or removed to form different embodiments of the present disclosure.

1. A method for translation of at least one web element, from a source language to a target language, the method comprising:
receiving a request for complete translation of said at least one web element;
parsing said at least one web element to identify a standard document object model tree and at least one dynamic content in said standard document object model tree, wherein
the parsing is one of a standard parsing of the at least one web element, a preconfigured parsing and combination thereof, and
the at least one dynamic content contains at least one code and at least one translatable text, where one of the at least one code and the at least one translatable text contains at least one of a fixed text, a varying text and combination thereof;
extracting at least one translatable text from the at least one code identified in the at least one dynamic content;
translating the at least one translatable text in the source language to at least one translated text in the target language; and
re-composing the at least one web element in the target language by replacing the at least one translatable text in the source language to at least one translated text in the target language.

2. The method as claimed in claim 1 may further comprise generating a regular expression code for the at least one dynamic content, wherein generation of regular expression code occurs prior to translation of the identified at least one dynamic content.

3. The method as claimed in claim 1 further comprises changing one of a format and layout of said at least one web element, wherein change in the format and the layout is performed before or after the translation of the identified at least one dynamic content of the at least one web element.

4. The method as claimed in claim 1, wherein the at least one dynamic content is one of a Cascading Style Sheet, a JavaScript, an Internal HTML Script tag, an image, a document, a standard JavaScript Object Notation, a non-standard JavaScript Object Notation, a Xml HTTP Request, a Direct Web Remoting, an Uniform Resource Locator and a combination thereof.

5. The method as claimed in claim 1, wherein the at least one dynamic content comprises data in one of standard, non-standard or proprietary formats and a combination thereof.

6. The method as claimed in claim 1, wherein the pre-configured parsing includes setting one of custom rules, actions, a manual activity and combination thereof.

7. The method of claim 1, wherein the translation of the translatable text is a context-based translation.

8. A system for translation of at least one web element, from a source language to a target language, the system comprising:
a transceiver unit [402] for receiving a request for complete translation of at least one web element;
a runtime engine [404] configured with the transceiver unit [402] for parsing the at least one web element to identify a standard document object model tree and at least one dynamic content in said standard document object model tree, wherein
the parsing is one of a standard parsing of the at least one web element, a preconfigured parsing and combination thereof, and
the at least one dynamic content contains at least a code and at least one translatable text, where one of the at least one code and the at least one translatable text contains at least one of a fixed text, a varying text and combination thereof;
a parser [406] configured for extracting at least one translatable text from the at least one code identified in the at least one dynamic content;
a translation engine [408] associated with said parser [406] for translating the at least one translatable text in the source language to at least one translated text in the target language; and
a web element re-composer [410] associated with said parser, configured for recomposing the at least one web element in the target language by replacing the at least one translatable text in the source language to at least one translated text in the target language.

9. The system of claim 8, wherein said at least one web element is one of a website, a web page, web control, web application and a combination thereof.

10. The system as claimed in claim 8, further comprising a pre-configurator unit comprising a regular expression generator for generating a regular expression code for extracting translatable text from the at least one dynamic content.
